(19) United States
(12) Patent Application Publication
(10) Pub. No.: US 2025/0336576 A1
(43) Pub. Date: Oct. 30, 2025

(54) THREE-DIMENSIONAL ELECTRODES FOR REFLOWABLE PTC DEVICE

(71) Applicant: Littelfuse, Inc., Rosemont, IL (US)

(72) Inventors: ChiHao Ku, New Taipei City (TW); Yu Tian, Shanghai (CN); Garrett Wang, Shanghai (CN); Sky Chen, Chicago, IL (US); Bing Wang, Shanghai (CN)

(73) Assignee: Littelfuse, Inc., Rosemont, IL (US)

(21) Appl. No.: 19/185,542

(22) Filed: Apr. 22, 2025

(30) Foreign Application Priority Data
Apr. 25, 2024 (CN) 202410503764.6

(51) Int. Cl. H01C 1/14; H01C 1/034; H01C 1/144; H01C 7/02; H01C 7/18

(52) U.S. Cl. CPC H01C 1/1406; H01C 1/034; H01C 1/144; H01C 7/02; H01C 7/18

(57) ABSTRACT

A three-dimensional electrode for a reflowable PTC device is provided. The three-dimensional electrode can include a planar portion for connecting with a PTC material on a top surface thereof or a bottom surface thereof, at least one expander portion electrically and physically connected with and perpendicular with the planar portion, and one or more terminals electrically and physically connected with the at least one expander portion, wherein the at least one expander portion can vertically or horizontally offset the one or more terminals from the planar portion.

### CROSS-REFERENCE TO RELATED APPLICATIONS

This application claims the benefit of priority to, Chinese Patent Application No. 202410503764.6, filed Apr. 25, 2024, entitled “THREE DIMENSIONAL ELECTRODES FOR REFLOWABLE PTC DEVICE,” which application is incorporated herein by reference in its entirety.

### FIELD

The present disclosure generally relates to reflowable PTC devices. More particularly, the present disclosure relates to three-dimensional electrodes for a reflowable PTC device.

### BACKGROUND

Reflowable positive temperature coefficient (PTC) devices are often used in high current field applications. However, current in such PTC devices have limited capabilities. Furthermore, electrical and mechanical requirements and limitations of field applications can vary. As such, there is a continuing, ongoing need for flexibility in electrical and mechanical designs of reflowable PTC devices.

### BRIEF SUMMARY

In some embodiments, a three-dimensional electrode can include a planar portion for connecting with a positive temperature coefficient (PTC) material on a top surface thereof or a bottom surface thereof, at least one expander portion electrically and physically connected with and perpendicular with the planar portion, and one or more terminals electrically and physically connected with the at least one expander portion, the at least one expander portion vertically or horizontally offsetting the one or more terminals from the planar portion.

In some embodiments, the one or more terminals can be parallel with the planar portion.

In some embodiments, the one or more terminals can be perpendicular with the planar portion.

In some embodiments, the three-dimensional electrode can include an insulation material covering at least part of the planar portion, the at least one expander portion, and the one or more terminals.

In some embodiments, at least part of the one or more terminals can be uncovered by the insulation material.

In some embodiments, parts of the one or more terminals facing away from the planar portion can be uncovered by the insulation material.

In some embodiments, a module can include a first three-dimensional electrode, a second three-dimensional electrode, and an insulation material covering at least part of the first three-dimensional electrode and the second three-dimensional electrode. The first three-dimensional electrode can include a first planar portion connected with a positive temperature coefficient (PTC) material on a top surface thereof, at least one first expander portion electrically and physically connected with and perpendicular with the first planar portion, and one or more first terminals electrically and physically connected with the at least one first expander portion, the at least one first expander portion vertically or horizontally offsetting the one or more first terminals from the first planar portion. The second three-dimensional electrode can include a second planar portion connected with the PTC material on a bottom surface thereof, at least one second expander portion electrically and physically connected with and perpendicular with the second planar portion, and one or more second terminals electrically and physically connected with the at least one second expander portion, the at least one second expander portion vertically or horizontally offsetting the one or more second terminals from the second planar portion.

In some embodiments, the one or more first terminals of the first three-dimensional electrode can be parallel with the first planar portion of the first three-dimensional electrode, and the one or more second terminals of the second three-dimensional electrode can be parallel with the second planar portion of the second three-dimensional electrode.

In some embodiments, the one or more first terminals of the first three-dimensional electrode can be perpendicular with the first planar portion of the first three-dimensional electrode, and the one or more second terminals of the second three-dimensional electrode can be perpendicular with the second planar portion of the second three-dimensional electrode.

In some embodiments, at least part of the one or more first terminals of the first three-dimensional electrode can be uncovered by the insulation material, and at least part of the one or more second terminals of the second three-dimensional electrode can be uncovered by the insulation material.

In some embodiments, parts of the one or more first terminals of the first three-dimensional electrode facing away from the first planar portion of the first three-dimensional electrode can be uncovered by the insulation material, and parts of the one or more second terminals of the second three-dimensional electrode facing away from the second planar portion of the second three-dimensional electrode can be uncovered by the insulation material.

In some embodiments, a lower surface of the PTC material can be electrically connected to the top surface of the of the first planar portion of the first three-dimensional electrode, and an upper surface of the PTC material can be electrically connected to the bottom surface of the second planar portion of the second three-dimensional electrode.

In some embodiments, a system can include a first three-dimensional electrode module and a second three-dimensional electrode module electrically connected to the first three-dimensional electrode module. Each of the first three-dimensional electrode module and the second three-dimensional electrode module can include a first three-dimensional electrode, a second three-dimensional electrode, and an insulation material covering at least part of the first three-dimensional electrode and the second three-dimensional electrode. The first three-dimensional electrode can include a first planar portion connected with a positive temperature coefficient (PTC) material on a top surface thereof, at least one first expander portion electrically and physically connected with and perpendicular with the first planar portion, and one or more first terminals electrically and physically connected with the at least one first expander portion, the at least one first expander portion vertically or horizontally offsetting the one or more first terminals from the first planar portion. The second three-dimensional electrode can include a second planar portion connected with the PTC material on a bottom surface thereof, at least one second expander portion electrically and physically connected with and perpendicular with the second planar portion, and one or more second terminals electrically and physically connected with the at least one second expander portion, the at least one second expander portion vertically or horizontally offsetting the one or more second terminals from the second planar portion.

In some embodiments, the one or more first terminals of the first three-dimensional electrode can be parallel with the first planar portion of the first three-dimensional electrode, and the one or more second terminals of the second three-dimensional electrode can be parallel with the second planar portion of the second three-dimensional electrode.

In some embodiments, the one or more first terminals of the first three-dimensional electrode can be perpendicular with the first planar portion of the first three-dimensional electrode, and the one or more second terminals of the second three-dimensional electrode can be perpendicular with the second planar portion of the second three-dimensional electrode.

In some embodiments, at least part of the one or more first terminals of the first three-dimensional electrode can be uncovered by the insulation material, and at least part of the one or more second terminals of the second three-dimensional electrode can be uncovered by the insulation material.

In some embodiments, parts of the one or more first terminals of the first three-dimensional electrode facing away from the first planar portion of the first three-dimensional electrode can be uncovered by the insulation material, and parts of the one or more second terminals of the second three-dimensional electrode facing away from the second planar portion of the second three-dimensional electrode can be uncovered by the insulation material.

In some embodiments, the first-three dimensional electrode module can be vertically stacked on top of the second three-dimensional electrode module or horizontally stacked next to the second three-dimensional electrode module, and the first three-dimensional electrode module can be electrically connected to the second three-dimensional electrode module in parallel via an electrical connection between the parts of the one or more first terminals of the first three-dimensional electrode module facing away from the first planar portion of the first three-dimensional electrode module and uncovered by the insulation material and the parts of the one or more second terminals of the second three-dimensional electrode module facing away from the second planar portion of the second three-dimensional electrode module and uncovered by the insulation material.

In some embodiments, the first-three dimensional electrode module can be vertically stacked on top of the second three-dimensional electrode module so that the first planar portion, the second planar portion, and the PTC material of the first three-dimensional electrode module can be parallel with the first planar portion, the second planar portion, and the PTC material of the second three-dimensional electrode module, and the first three-dimensional electrode module can be electrically connected to the second three-dimensional electrode module in parallel.

In some embodiments, the first-three dimensional electrode module can be horizontally stacked next to the second three-dimensional electrode module so that the first planar portion, the second planar portion, and the PTC material of the first three-dimensional electrode module can be offset 180° from the first planar portion, the second planar portion, and the PTC material of the second three-dimensional electrode module, and the first three-dimensional electrode module can be electrically connected to the second three-dimensional electrode module in parallel.

Other technical features may be readily apparent to one skilled in the art from the following figures, descriptions, and claims.

### BRIEF DESCRIPTION OF THE SEVERAL VIEWS OF THE DRAWINGS

FIG. 1 is an exploded view of three-dimensional electrodes and a PTC material in accordance with disclosed embodiments.

FIG. 2A is an exploded view of a three-dimensional electrode module in accordance with disclosed embodiments.

FIG. 2B is an exploded view of a three-dimensional electrode module in accordance with disclosed embodiments.

FIG. 2C is an exploded view of a three-dimensional electrode module in accordance with disclosed embodiments.

FIG. 2D is a perspective view of a three-dimensional electrode module in accordance with disclosed embodiments.

FIG. 2E is a top view of a three-dimensional electrode module in accordance with disclosed embodiments.

FIG. 2F is a side view of a three-dimensional electrode module in accordance with disclosed embodiments.

FIG. 3A is an exploded view of a three-dimensional electrode module in accordance with disclosed embodiments.

FIG. 3B is an exploded view of a three-dimensional electrode module in accordance with disclosed embodiments.

FIG. 3C is an exploded view of a three-dimensional electrode module in accordance with disclosed embodiments.

FIG. 3D is a perspective view of a three-dimensional electrode module in accordance with disclosed embodiments.

FIG. 3E is a top view of a three-dimensional electrode module in accordance with disclosed embodiments.

FIG. 3F is a side view of a three-dimensional electrode module in accordance with disclosed embodiments.

FIG. 4A is an exploded view of a three-dimensional electrode module in accordance with disclosed embodiments.

FIG. 4B is an exploded view of a three-dimensional electrode module in accordance with disclosed embodiments.

FIG. 4C is an exploded view of a three-dimensional electrode module in accordance with disclosed embodiments.

FIG. 4D is a perspective view of a three-dimensional electrode module in accordance with disclosed embodiments.

FIG. 4E is an end view of a three-dimensional electrode module in accordance with disclosed embodiments.

FIG. 4F is a bottom view of a three-dimensional electrode module in accordance with disclosed embodiments.

FIG. 4G is an end view of a three-dimensional electrode module in accordance with disclosed embodiments.

FIG. 4H is a side view of a three-dimensional electrode module in accordance with disclosed embodiments.

FIG. 4I is a top view of a three-dimensional electrode module in accordance with disclosed embodiments.

FIG. 5A is a side view of a three-dimensional electrode system in accordance with disclosed embodiments.

FIG. 5B is a perspective view of a three-dimensional electrode system in accordance with disclosed embodiments.

FIG. 6A is a side view of a three-dimensional electrode system in accordance with disclosed embodiments.

FIG. 6B is a perspective view of a three-dimensional electrode system in accordance with disclosed embodiments.

FIG. 7 is a circuit diagram representative of a three-dimensional electrode system in accordance with disclosed embodiments.

FIG. 8 is a flow diagram of a method in accordance with disclosed embodiments.

FIG. 9 is a flow diagram of a method in accordance with disclosed embodiments.

### DETAILED DESCRIPTION

Exemplary embodiments of a three-dimensional electrode for a reflowable PTC device in accordance with the present disclosure will now be described more fully hereinafter with reference made to the accompanying drawings. The three-dimensional electrode may, however, be embodied in many different forms and should not be construed as being limited to the embodiments set forth herein. Rather, these embodiments are provided so that this disclosure will convey certain exemplary aspects of the three-dimensional electrode to those skilled in the art.

In accordance with disclosed embodiments, a three-dimensional electrode, a three-dimensional electrode module, and/or a three-dimensional electrode system can be used in connection with a reflowable PTC device to expand current capability of such a PTC device. In particular, a plurality of three-dimensional electrodes in a plurality of three-dimensional electrode modules in the three-dimensional electrode system can be connected in parallel to expand the current capability of PTC devices electrically connected to the three-dimensional electrodes, for example, in high current field applications. The disclosed three-dimensional shape enables the three-dimensional electrode and/or the three-dimensional electrode modules to be stacked like Lego® plastic bricks either vertically and/or horizontally.

In some embodiments, a three-dimensional electrode can include a planar portion for connecting with a positive temperature coefficient (PTC) material on a top surface thereof or a bottom surface thereof, at least one expander portion electrically and physically connected with and perpendicular with the planar portion, and one or more terminals electrically and physically connected with the at least one expander portion such that the at least one expander portion can vertically and/or horizontally offset the one or more terminals from the planar portion.

In some embodiments, the terminals can be parallel with the planar portion. Additionally or alternatively, in some embodiments, the terminals can be perpendicular with the planar portion.

The three-dimensional electrode can be any material for electrodes as would be understood by one of ordinary skill in the art. For example, in some embodiments, the three-dimensional electrode can be copper, zinc, lead, silver, graphite, platinum, gold, and/or rhodium. In some embodiments, the three-dimensional electrode can be formed from one piece of material. For example, the planar portion, the expander portion, and the terminals can be contiguous. In some embodiments, the one piece of material can be stamped and bent or otherwise formed into the planar portion, the expander portion, and the terminals as disclosed herein.

In some embodiments, the PTC material can be made of or from a solid sheet of the PTC material, a liquid version of the PTC material, and/or a conductive chip with the PTC material. Additionally or alternatively, in some embodiments, the PTC material can be inserted into or onto the three-dimensional electrode by soldering and/or injection molding. In some embodiments, the PTC material can include a polymeric PTC (PPTC) material that can either be a solid sheet covered by a foil on top and bottom sides thereof or a liquid material that can connect directly with the planar portion.

In some embodiments, an insulation material can cover the three-dimensional electrode, including, for example, at least part of the planar portion, the expander portion, and/or the terminals. Additionally or alternatively, in some embodiments, at least part of the terminals can be uncovered by the insulation material. For example, in some embodiments, parts of the terminals facing away from the planar portion can be uncovered by the insulation material. As such, the insulation material can cover rest areas of the terminals. The insulation material can be any type of molding material or cap assembly as would be understood by one of ordinary skill in the art.

In some embodiments, a three-dimensional electrode module can include a first three-dimensional electrode in accordance with disclosed embodiments, a second three-dimensional in accordance with disclosed embodiments, and the insulation material covering at least part of the first three-dimensional electrode and the second three-dimensional electrode. A top surface of the planar portion of the first three-dimensional electrode can be connected with the PTC material, and a bottom surface of the planar portion of the second three-dimensional electrode can be connected with the PTC material. For example, in some embodiments, a lower surface of the PTC material can be electrically connected to the top surface of the planar portion of the first three-dimensional electrode, and an upper surface of the PTC material can be electrically connected to the bottom surface of the planar portion of the second three-dimensional electrode. As such, the PTC material can be electrically connected to two different three-dimensional electrodes.

In some embodiments, a three-dimensional electrode system can include a first three-dimensional electrode module in accordance with disclosed embodiments and a second three-dimensional electrode module in accordance with disclosed embodiments electrically connected to the first three-dimensional electrode module. In particular, in some embodiments, the first three-dimensional electrode module can be electrically connected to the second three-dimensional module in parallel. For example, in some embodiments, the first three-dimensional electrode module can be electrically connected to the second three-dimensional module via an electrical connection between parts of the terminals of the first three-dimensional electrode module facing away from planar portions of the first three-dimensional electrode module and uncovered by the insulation material and parts of the terminals of the second three-dimensional electrode module facing away from planar portions of the second three-dimensional electrode module and uncovered by the insulation material.

In some embodiments, the first three-dimensional electrode module can be vertically stacked on top of the second three-dimensional electrode module so that the planar portions and the PTC material of the first three-dimensional electrode module are parallel with the planar portions and the PTC material of the second three-dimensional electrode module. In these embodiments, the terminals of the first three-dimensional electrode module and the terminals of the second three-dimensional electrode module can be located on tops and bottoms thereof to facilitate electrical connections therebetween when stacked vertically. Additionally or alternatively, in some embodiments, the first three-dimensional electrode module can be horizontally stacked next to the second three-dimensional electrode module so that the planar portions and the PTC material of the first three-dimensional electrode module are offset 180° from the planar portions and the PTC material of the second three-dimensional electrode module. In these embodiments, the terminals of the first three-dimensional electrode module and the terminals of the second three-dimensional electrode module can be located on sides thereof to facilitate electrical connections therebetween when stacked horizontally. Additionally or alternatively, in some embodiments, the first three-dimensional electrode module can be vertically stacked on top of the second three-dimensional electrode, and a third three-dimensional electrode module can be horizontally stacked next to the second three-dimensional electrode module. In these embodiments, the terminals of the second three-dimensional electrode module can be located on tops, bottoms, and sides thereof to facilitate electrical connections when stacked both vertically and horizontally.

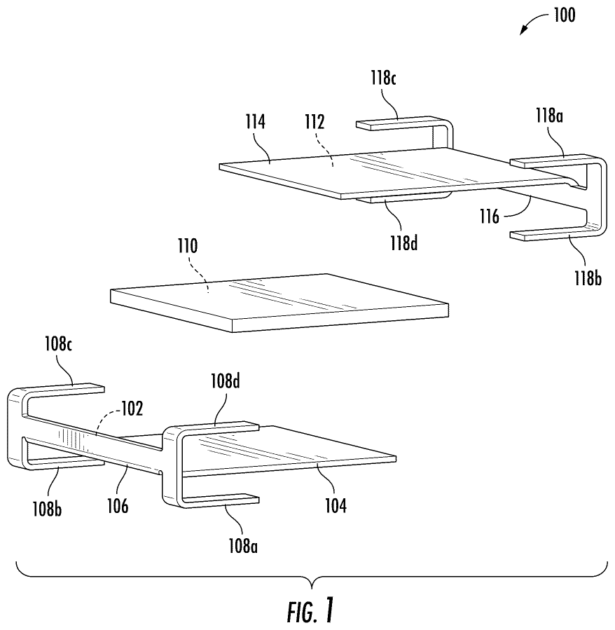

FIG. 1 illustrates a first three-dimensional electrode 102, a second three-dimensional electrode 112, and a PTC material 110 in accordance with disclosed embodiments. As seen, the first three-dimensional electrode 102 can include a planar portion 104 for connecting with the PTC material 110, and the second three-dimensional electrode 112 can include a planar portion for connecting with the PTC material 110. In particular, a top surface of the planar portion 104 of the first three-dimensional electrode 102 can connect with the PTC material 110, and a bottom surface of the planar portion 114 of the second three-dimensional electrode 112 can connect with the PTC material 110. In some embodiments, one or both of the planar portion 104 and the planar portion 114 can include a flat piece of material with a shape, such as a rectangular or square shape, sized for connecting with the PTC material 110.

In some embodiments, the PTC material 110 can be made of or from a solid sheet of the PTC material 110, a liquid version of the PTC material 110, and/or a conductive chip with the PTC material 110. Additionally or alternatively, in some embodiments, the PTC material 110 can be inserted into or onto one or both of the first three-dimensional electrode 102 and the second three-dimensional electrode 112 by soldering and/or injection molding. In some embodiments, the PTC material 110 can include a polymeric PTC (PPTC) material that can either be a solid sheet covered by a foil on top and bottom sides thereof or a liquid material that can connect directly with the planar portion.

As seen in FIG. 1, the first three-dimensional electrode 102 can also include an expander portion 106 and terminals 108a, 108b, 108c, 108d, and the second three-dimensional electrode 112 can also include an expander portion 116 and terminals 118a, 118b, 118c, 118d. Although four terminals 108a, 108b, 108c, 108d are illustrated in connection with the first three-dimensional electrode 102 and four terminals 118a, 118b, 118c, 118d are illustrated in connection with the second three-dimensional electrode 112, embodiments disclosed herein are not so limited. Instead, each of the first three-dimensional electrode 102 and the second three-dimensional electrode 112 can more or less than four terminals.

The expander portion 106 of the first three-dimensional electrode 102 can be electrically and physically connected with and perpendicular to the planar portion 104 of the first three-dimensional electrode 102, and the expander portion 116 of the second three-dimensional electrode 112 can be electrically and physically connected with and perpendicular to the planar portion 114 of the second three-dimensional electrode 112. Further, the terminals 108a, 108b, 108c, 108d of the first three-dimensional electrode 102 can be electrically and physically connected with the expander portion 106 of the first three-dimensional electrode 102, and the expander portion 106 of the first three-dimensional electrode 102 can vertically and/or horizontally offset the terminals 108a, 108b, 108c, 108d of the first three-dimensional electrode 102 from the planar portion 104 of the first three-dimensional electrode 102. Similarly, the terminals 118a, 118b, 118c, 118d of the second three-dimensional electrode 112 can be electrically and physically connected with the expander portion 116 of the second three-dimensional electrode 112, and the expander portion 116 of the second three-dimensional electrode 112 can vertically and/or horizontally offset the terminals 118a, 118b, 118c, 118d of the second three-dimensional electrode 112 from the planar portion 114 of the second three-dimensional electrode 112.

As seen in FIG. 1, the terminals 108a, 108b, 108c, 108d of the first three-dimensional electrode 102 can be parallel with the planar portion 104 of the first three-dimensional electrode 102, and the terminals 118a, 118b, 118c, 118d of the second three-dimensional electrode 112 can be parallel with the planar portion 114 of the second three-dimensional electrode 112. However, embodiments disclosed herein are not so limited. For example, the terminals 108a, 108b, 108c, 108d of the first three-dimensional electrode 102 can be additionally or alternatively perpendicular with the planar portion 104 of the first three-dimensional electrode 102 and/or the terminals 118a, 118b, 118c, 118d of the second three-dimensional electrode 112 can be additionally or alternatively perpendicular with the planar portion 114 of the second three-dimensional electrode 112.

Each of the first three-dimensional electrode 102 and the second three-dimensional electrode 112 can be any material for electrodes as would be understood by one of ordinary skill in the art. For example, in some embodiments, one or both of the first three-dimensional electrode 102 and the second three-dimensional electrode 112 can be copper, zinc, lead, silver, graphite, platinum, gold, and/or rhodium. In some embodiments, one or both of the first three-dimensional electrode 102 and the second three-dimensional electrode 112 can be formed from one piece of material. For example, the planar portion 104, the expander portion 106, and the terminals 108a, 108b, 108c, 108d of the first three-dimensional electrode 102 can be contiguous and/or the planar portion 114, the expander portion 116, and the terminals 118a, 118b, 118c, 118d of the second three-dimensional electrode 112 can be contiguous. In some embodiments, the one piece of material can be stamped and bent or otherwise formed into the planar portion 104, the expander portion 106, and the terminals 108a, 108b, 108c, 108d of the first three-dimensional electrode 102 of the first three-dimensional electrode 102 as disclosed herein and/or into the planar portion 114, the expander portion 116, and the terminals 118a, 118b, 118c, 118d of the second three-dimensional electrode 112 as disclosed herein.

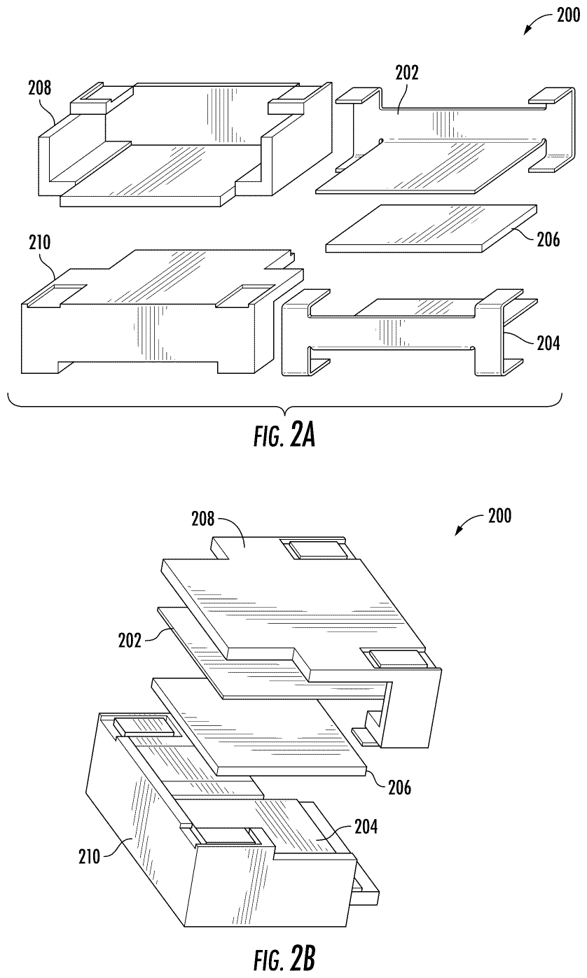

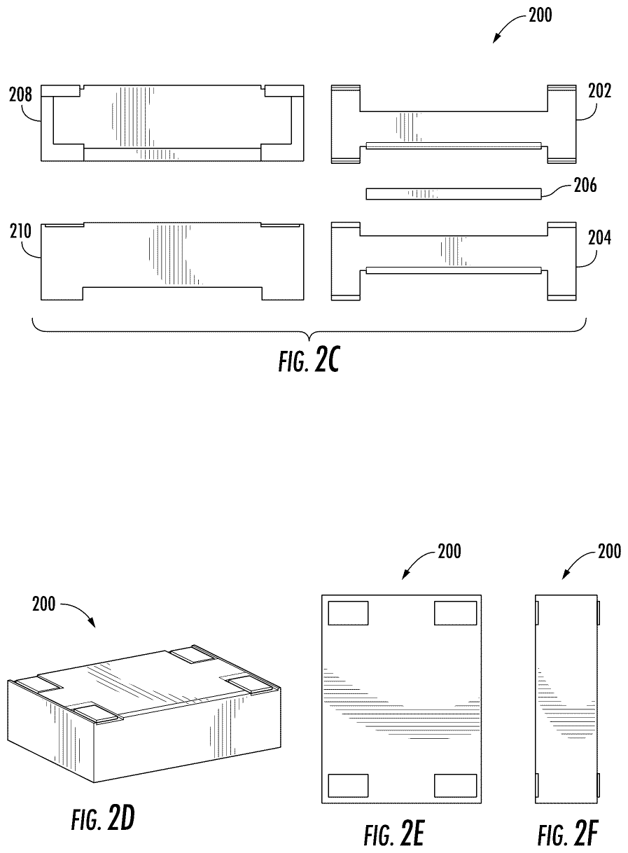

FIG. 2A, FIG. 2B, FIG. 2C, FIG. 2D, FIG. 2E, and FIG. 2F illustrate one embodiment of a three-dimensional electrode module 200 in accordance with disclosed embodiments. As seen, the three-dimensional electrode module 200 can include a first three-dimensional electrode 204, a second three-dimensional electrode 202, a PTC material 206, an insulation material 208, and an insulation material 210. In these embodiments, one layer of the PTC material 206 is included in the one three-dimensional electrode module 200.

It is to be understood that the first three-dimensional electrode 204 can be the same as or similar to the first three-dimensional electrode 102, the second three-dimensional electrode 202 can be the same as or similar to the second three-dimensional electrode 112, and the PTC material 206 can be the same as or similar to the PTC material 110. In this regard, a top surface of the planar portion of the first three-dimensional electrode 204 can be connected with the PTC material 206, and a bottom surface of the planar portion of the second three-dimensional electrode 202 can be connected with the PTC material 206. For example, in some embodiments, a lower surface of the PTC material 206 can be electrically connected to the top surface of the planar portion of the first three-dimensional electrode 204, and an upper surface of the PTC material 206 can be electrically connected to the bottom surface of the planar portion of the second three-dimensional electrode 202. As such, the PTC material 206 can be electrically connected to both the first three-dimensional electrode 204 and the second three-dimensional electrode 202.

However, embodiments disclosed are not so limited. For example, one or both of the first three-dimensional electrode 204 and the second three-dimensional electrode 202 could be any type of three-dimensional electrode that comes within the spirit and scope of embodiments disclosed herein. Similarly, the PTC material 206 can be any type of PTC material that comes within the spirit and scope of embodiments disclosed herein.

It is also to be understood that one or both of the insulation material 208 and the insulation material 210 can be any type of molding material or cap assembly as would be understood by one of ordinary skill in the art.

As seen in FIG. 2A, FIG. 2B, FIG. 2C, FIG. 2D, FIG. 2E, and FIG. 2F, the insulation material 210 can cover the first three-dimensional electrode 204, including, for example, at least part of the planar portion, the expander portion, and/or the terminals of the first three-dimensional electrode 204. Additionally or alternatively, in some embodiments, at least part of the terminals of the first three-dimensional electrode 204 can be uncovered by the insulation material 210. For example, in some embodiments, parts of the terminals of the first three-dimensional electrode 204 facing away from the planar portion of the first three-dimensional electrode 204 can be uncovered by the insulation material 210. As such, the insulation material 210 can cover rest areas of the terminals of the first three-dimensional electrode 204.

As also seen in FIG. 2A, FIG. 2B, FIG. 2C, FIG. 2D, FIG. 2E, and FIG. 2F, the insulation material 208 can cover the second three-dimensional electrode 202, including, for example, at least part of the planar portion, the expander portion, and/or the terminals of the second three-dimensional electrode 202. Additionally or alternatively, in some embodiments, at least part of the terminals of the second three-dimensional electrode 202 can be uncovered by the insulation material 208. For example, in some embodiments, parts of the terminals of the second three-dimensional electrode 202 facing away from the planar portion of the second three-dimensional electrode 202 can be uncovered by the insulation material 208. As such, the insulation material 208 can cover rest areas of the terminals of the second three-dimensional electrode 202.

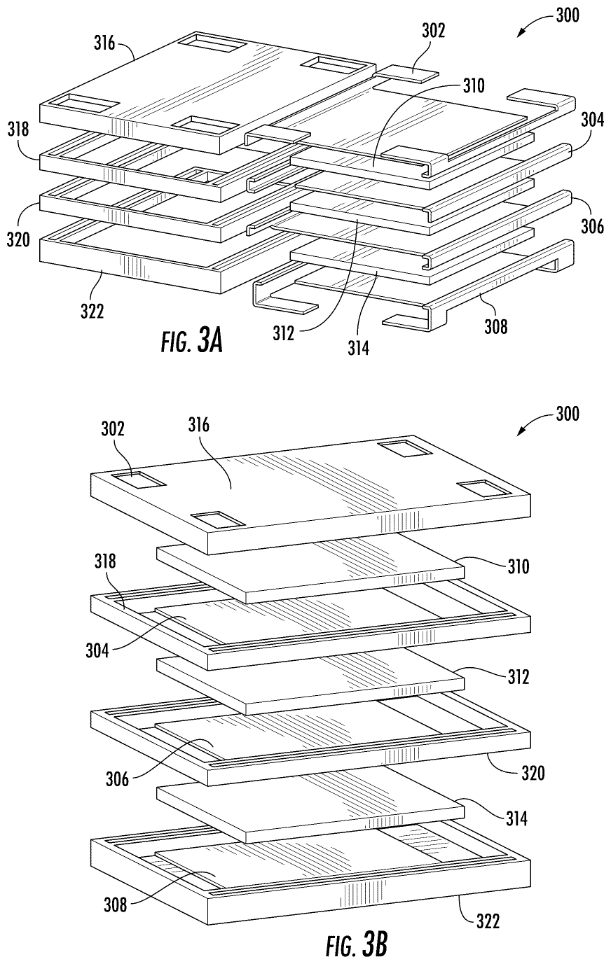

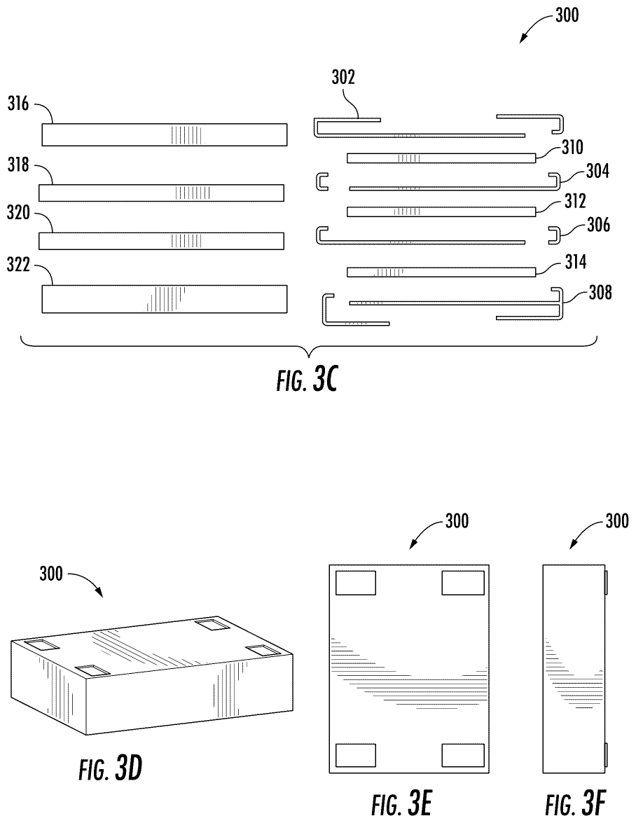

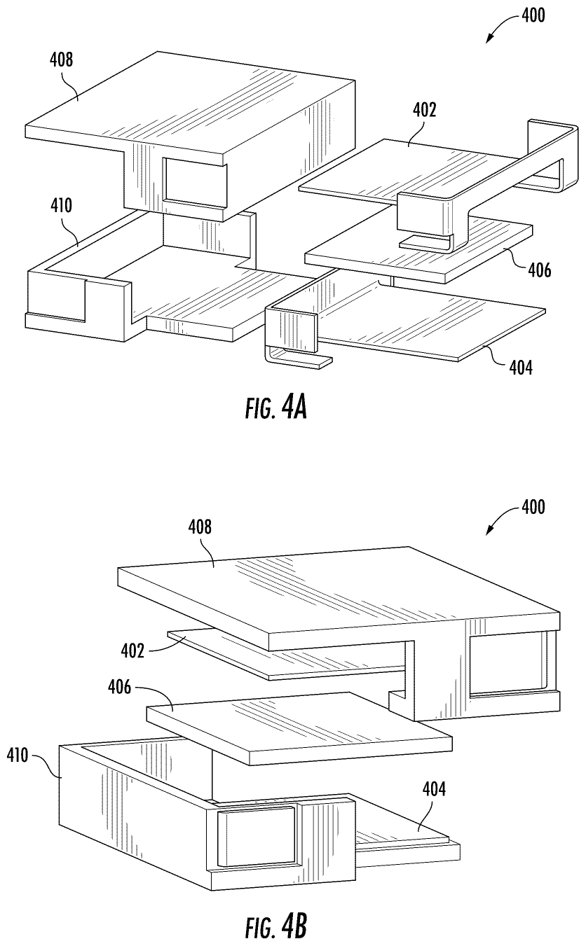

FIG. 3A, FIG. 3B, FIG. 3C, FIG. 3D, FIG. 3E, and FIG. 3F illustrate another embodiment of a three-dimensional electrode module 300 in accordance with disclosed embodiments. As seen, the three-dimensional electrode module 300 can include a first three-dimensional electrode 302, a second three-dimensional electrode 304, a third three-dimensional electrode 306, a fourth three-dimensional electrode 308, a PTC material 310, a PTC material 312, a PTC material 314, an insulation material 316, an insulation material 318, an insulation material 320, and an insulation material 322. In these embodiments, multiple layers of the PTC material 310, 312, 314 are included in the one three-dimensional electrode module 300.

It is to be understood that one or more of the first three-dimensional electrode 302, the second three-dimensional electrode 304, the third three-dimensional electrode 306, and the fourth three-dimensional electrode 308 can be the same as or similar to the first three-dimensional electrode 102 and/or the second three-dimensional electrode 112 and that one or more of the PTC material 310, the PTC material 312, and the PTC material 314 can be the same as or similar to the PTC material 110. In this regard, a top surface of the planar portion of the fourth three-dimensional electrode 308 can be connected with the PTC material 314, and a bottom surface of the planar portion of the third three-dimensional electrode 306 can be connected with the PTC material 314. For example, in some embodiments, a lower surface of the PTC material 314 can be electrically connected to the top surface of the planar portion of the fourth three-dimensional electrode 308, and an upper surface of the PTC material 314 can be electrically connected to the bottom surface of the planar portion of the third three-dimensional electrode 306. As such, the PTC material 314 can be electrically connected to both the fourth three-dimensional electrode 308 and the third three-dimensional electrode 306.

Similarly, a top surface of the planar portion of the third three-dimensional electrode 306 can be connected with the PTC material 312, and a bottom surface of the planar portion of the second three-dimensional electrode 304 can be connected with the PTC material 312. For example, in some embodiments, a lower surface of the PTC material 312 can be electrically connected to the top surface of the planar portion of the third three-dimensional electrode 306, and an upper surface of the PTC material 312 can be electrically connected to the bottom surface of the planar portion of the second three-dimensional electrode 304. As such, the PTC material 312 can be electrically connected to both the third three-dimensional electrode 306 and the second three-dimensional electrode 304, and the third three-dimensional electrode 306 can be electrically connected to both the PTC material 314 and the PTC material 312.

Similarly, a top surface of the planar portion of the second three-dimensional electrode 304 can be connected with the PTC material 310, and a bottom surface of the planar portion of the first three-dimensional electrode 302 can be connected with the PTC material 310. For example, in some embodiments, a lower surface of the PTC material 310 can be electrically connected to the top surface of the planar portion of the second three-dimensional electrode 304, and an upper surface of the PTC material 310 can be electrically connected to the bottom surface of the planar portion of the first three-dimensional electrode 302. As such, the PTC material 310 can be electrically connected to both the second three-dimensional electrode 304 and the first three-dimensional electrode 302, and the second three-dimensional electrode 304 can be electrically connected to both the PTC material 312 and the PTC material 310.

However, embodiments disclosed are not so limited. For example, one or more of the first three-dimensional electrode 302, the second three-dimensional electrode 304, the third three-dimensional electrode 306, and the fourth three-dimensional electrode 308 could be any type of three-dimensional electrode that comes within the spirit and scope of embodiments disclosed herein. Similarly, one or more of the PTC material 310, the PTC material 312, and the PTC material 314 can be any type of PTC material that comes within the spirit and scope of embodiments disclosed herein.

It is also to be understood that one or more of the insulation material 316, the insulation material 318, the insulation material 320, and the insulation material 322 can be any type of molding material or cap assembly as would be understood by one of ordinary skill in the art.

As seen in FIG. 3A, FIG. 3B, FIG. 3C, FIG. 3D, FIG. 3E, and FIG. 3F, the insulation material 316 can cover the first three-dimensional electrode 302, including, for example, at least part of the planar portion, the expander portion, and/or the terminals of the first three-dimensional electrode 302. Additionally or alternatively, in some embodiments, at least part of the terminals of the first three-dimensional electrode 302 can be uncovered by the insulation material 316. For example, in some embodiments, parts of the terminals of the first three-dimensional electrode 302 facing away from the planar portion of the first three-dimensional electrode 302 can be uncovered by the insulation material 316. As such, the insulation material 316 can cover rest areas of the terminals of the first three-dimensional electrode 302.

As also seen in FIG. 3A, FIG. 3B, FIG. 3C, FIG. 3D, FIG. 3E, and FIG. 3F, the insulation material 322 can cover the fourth three-dimensional electrode 308, including, for example, at least part of the planar portion, the expander portion, and/or the terminals of the fourth three-dimensional electrode 308. Additionally or alternatively, in some embodiments, at least part of the terminals of the fourth three-dimensional electrode 308 can be uncovered by the insulation material 322. For example, in some embodiments, parts of the terminals of the fourth three-dimensional electrode 308 facing away from the planar portion of the fourth three-dimensional electrode 308 can be uncovered by the insulation material 322. As such, the insulation material 322 can cover rest areas of the terminals of the fourth three-dimensional electrode 308.

However, as seen in FIG. 3A, FIG. 3B, FIG. 3C, FIG. 3D, FIG. 3E, and FIG. 3F, the insulation material 318 can cover the second three-dimensional electrode 304, including, for example, all of the planar portion, the expander portion, and/or the terminals of the second three-dimensional electrode 304. Similarly, the insulation material 320 can cover the third three-dimensional electrode 306, including, for example, all of the planar portion, the expander portion, and/or the terminals of the third three-dimensional electrode 306.

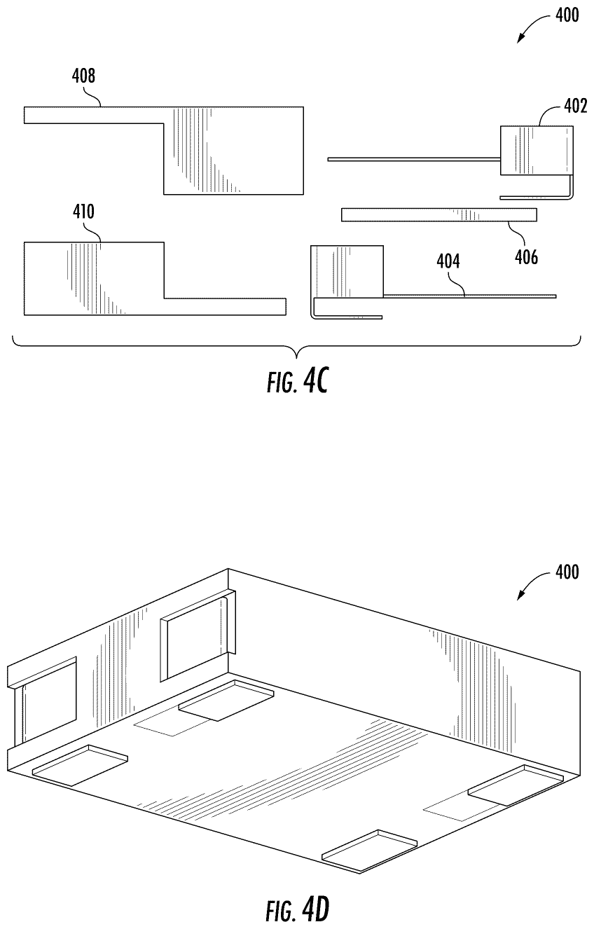

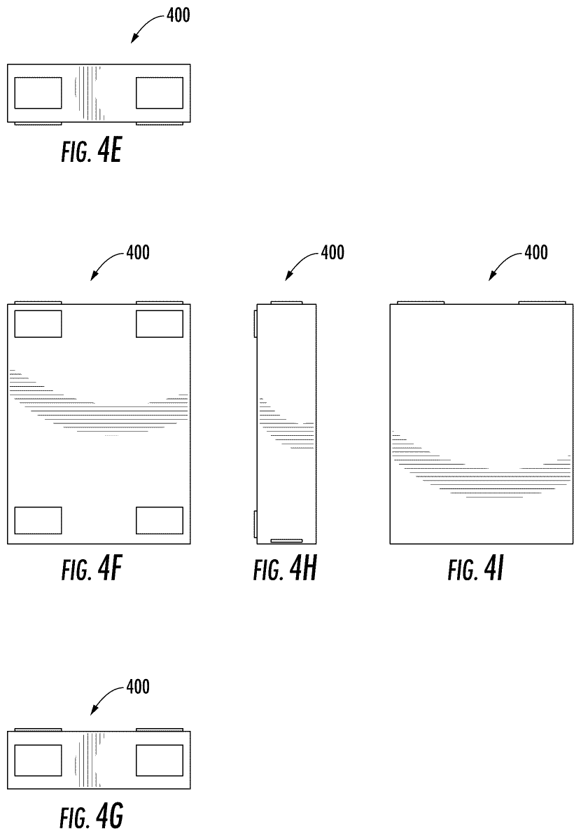

FIG. 4A, FIG. 4B, FIG. 4C, FIG. 4D, FIG. 4E, FIG. 4F, FIG. 4G, FIG. 4H, and FIG. 4I illustrate another embodiment of a three-dimensional electrode module 400 in accordance with disclosed embodiments. As seen, the three-dimensional electrode module 400 can include a first three-dimensional electrode 404, a second three-dimensional electrode 402, a PTC material 406, an insulation material 408, and an insulation material 410. In these embodiments, one layer of the PTC material 406 is included in the one three-dimensional electrode module 400.

It is to be understood that the first three-dimensional electrode 404 can be the same as or similar to the first three-dimensional electrode 102, the second three-dimensional electrode 402 can be the same as or similar to the second three-dimensional electrode 112, and the PTC material 406 can be the same as or similar to the PTC material 110. In this regard, a top surface of the planar portion of the first three-dimensional electrode 404 can be connected with the PTC material 406, and a bottom surface of the planar portion of the second three-dimensional electrode 402 can be connected with the PTC material 406. For example, in some embodiments, a lower surface of the PTC material 406 can be electrically connected to the top surface of the planar portion of the first three-dimensional electrode 404, and an upper surface of the PTC material 406 can be electrically connected to the bottom surface of the planar portion of the second three-dimensional electrode 402. As such, the PTC material 406 can be electrically connected to both the first three-dimensional electrode 404 and the second three-dimensional electrode 402.

However, embodiments disclosed are not so limited. For example, one or both of the first three-dimensional electrode 404 and the second three-dimensional electrode 402 could be any type of three-dimensional electrode that comes within the spirit and scope of embodiments disclosed herein. Similarly, the PTC material 406 can be any type of PTC material that comes within the spirit and scope of embodiments disclosed herein.

It is also to be understood that one or both of the insulation material 408 and the insulation material 410 can be any type of molding material or cap assembly as would be understood by one of ordinary skill in the art.

As seen in FIG. 4A, FIG. 4B, FIG. 4C, FIG. 4D, FIG. 4E, FIG. 4F, FIG. 4G, FIG. 4H, and FIG. 4I, the insulation material 410 can cover the first three-dimensional electrode 404, including, for example, at least part of the planar portion, the expander portion, and/or the terminals of the first three-dimensional electrode 404. Additionally or alternatively, in some embodiments, at least part of the terminals of the first three-dimensional electrode 404 can be uncovered by the insulation material 410. For example, in some embodiments, parts of the terminals of the first three-dimensional electrode 404 facing away from the planar portion of the first three-dimensional electrode 404 can be uncovered by the insulation material 410. As such, the insulation material 410 can cover rest areas of the terminals of the first three-dimensional electrode 404.

As also seen in FIG. 4A, FIG. 4B, FIG. 4C, FIG. 4D, FIG. 4E, FIG. 4F, FIG. 4G, FIG. 4H, and FIG. 4I, the insulation material 408 can cover the second three-dimensional electrode 402, including, for example, at least part of the planar portion, the expander portion, and/or the terminals of the second three-dimensional electrode 402. Additionally or alternatively, in some embodiments, at least part of the terminals of the second three-dimensional electrode 402 can be uncovered by the insulation material 408. For example, in some embodiments, parts of the terminals of the second three-dimensional electrode 402 facing away from the planar portion of the second three-dimensional electrode 402 can be uncovered by the insulation material 408. As such, the insulation material 408 can cover rest areas of the terminals of the second three-dimensional electrode 402.

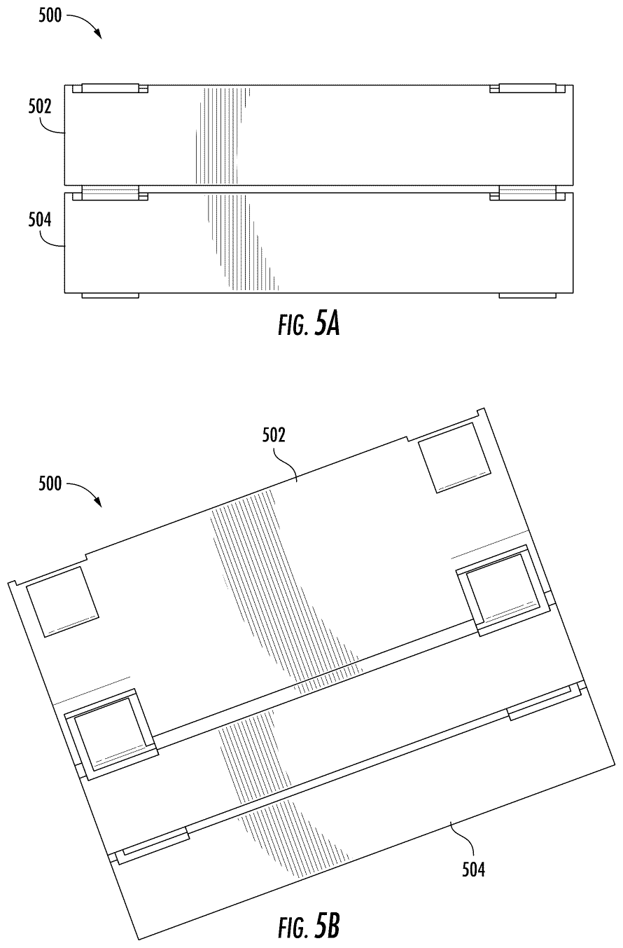

FIG. 5A and FIG. 5B illustrate one embodiment of a three-dimensional electrode system 500 in accordance with disclosed embodiments. As seen, the three-dimensional electrode system 500 can include a first three-dimensional electrode module 502 and a second three-dimensional electrode module 504.

It is to be understood that one or both of the first three-dimensional electrode module 502 and the second three-dimensional electrode module 504 can be the same as or similar to the three-dimensional electrode module 200, the three-dimensional electrode module 300, and/or the three-dimensional electrode module 400. However, embodiments disclosed herein are not so limited. For example, one or both of the first three-dimensional electrode module 502 and the second three-dimensional electrode module 504 could be any type of three-dimensional electrode module that comes within the spirit and scope of embodiments disclosed herein.

Although the three-dimensional electrode system 500 is illustrated with two three-dimensional electrode modules, it is also to be understood that embodiments disclosed herein are not so limited. Instead, the three-dimensional electrode system 500 can include any number of three-dimensional electrode modules as desired to satisfy electrical and mechanical needs of a field application.

As seen in FIG. 5A and FIG. 5B, the first three-dimensional electrode module 502 can be stacked vertically on top of the second three-dimensional electrode module 504 and electrically connected in parallel via an electrical connection between terminals on a bottom of the first three-dimensional electrode module 502 and terminals on a top of the second three-dimensional electrode module 504. That is, the terminals of the first three-dimensional electrode module 502 and the terminals of the second three-dimensional electrode module 504 can be located on tops and bottoms thereof to facilitate electrical connections therebetween when stacked vertically.

In particular, the first three-dimensional electrode module 502 can be electrically connected to the second three-dimensional electrode module 504 via the electrical connection between parts of the terminals of the first three-dimensional electrode module 502 facing away from planar portions of the first three-dimensional electrode module 502 and uncovered by insulation material and parts of the terminals of the second three-dimensional electrode module 504 facing away from planar portions of the second three-dimensional electrode module 504 and uncovered by insulation material. That is, those terminals forming the electrical connection between the first three-dimensional electrode module 502 and the second three-dimensional electrode module 504 can be uncovered by insulation materials.

When stacked vertically as in FIG. 5A and FIG. 5B, the planar portions and PTC material of the first three-dimensional electrode module 502 can be parallel with the planar portions and PTC material of the second three-dimensional electrode module 504.

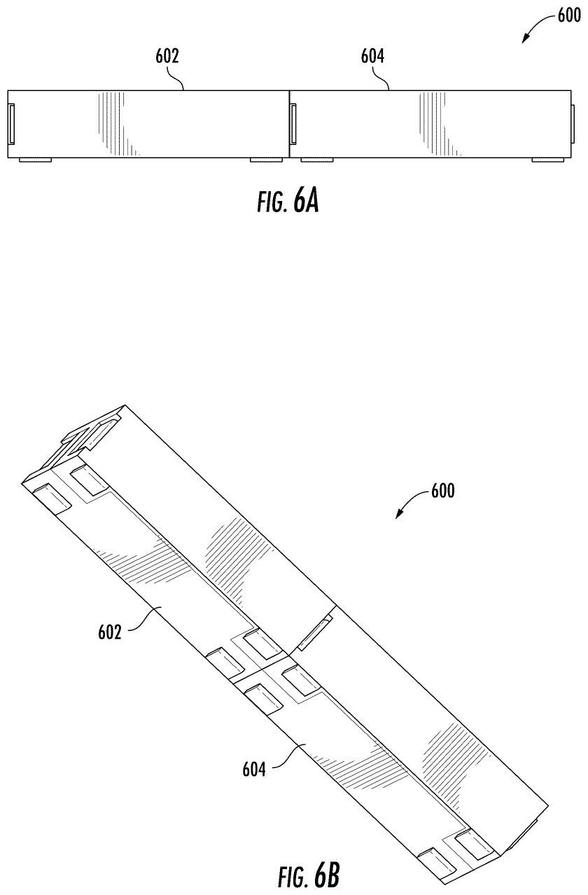

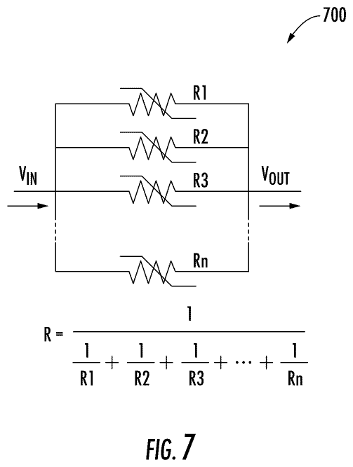

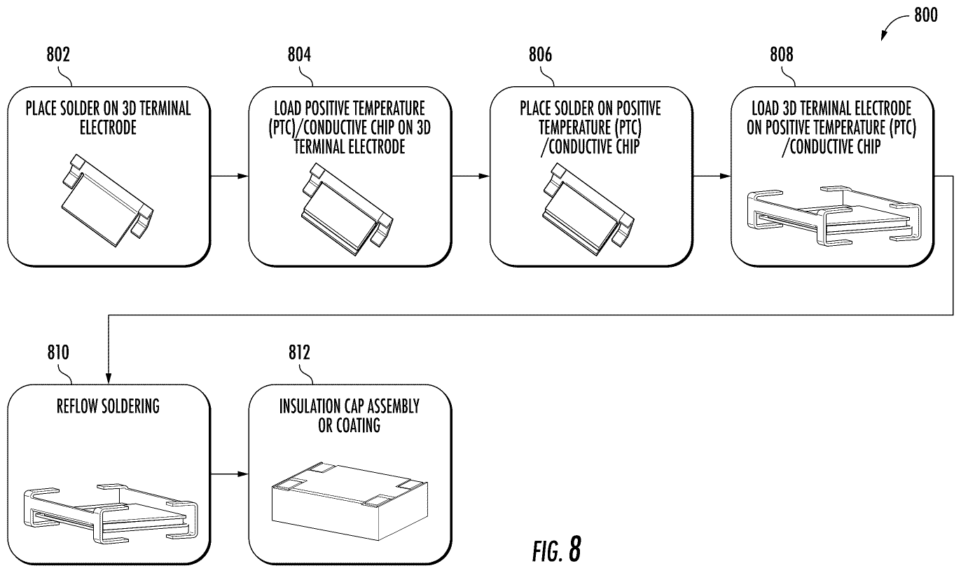

FIG. 6A and FIG. 6B illustrate another embodiment of a three-dimensional electrode system 600 in accordance with disclosed embodiments. As seen, the three-dimensional electrode system 600 can include a first three-dimensional electrode module 602 and a second three-dimensional electrode module 604.

It is to be understood that one or both of the first three-dimensional electrode module 602 and the second three-dimensional electrode module 604 can be the same as or similar to the three-dimensional electrode module 200, the three-dimensional electrode module 300, and/or the three-dimensional electrode module 400. However, embodiments disclosed herein are not so limited. For example, one or both of the first three-dimensional electrode module 602 and the second three-dimensional electrode module 604 could be any type of three-dimensional electrode module that comes within the spirit and scope of embodiments disclosed herein.

Although the three-dimensional electrode system 600 is illustrated with two three-dimensional electrode modules, it is also to be understood that embodiments disclosed herein are not so limited. Instead, the three-dimensional electrode system 600 can include any number of three-dimensional electrode modules as desired to satisfy electrical and mechanical needs of a field application.

As seen in FIG. 6A and FIG. 6B, the first three-dimensional electrode module 602 can be stacked horizontally next to the second three-dimensional electrode module 604 and electrically connected in parallel via an electrical connection between terminals on a side of the first three-dimensional electrode module 602 and terminals on a side of the second three-dimensional electrode module 604. That is, the terminals of the first three-dimensional electrode module 602 and the terminals of the second three-dimensional electrode module 604 can be located on sides thereof to facilitate electrical connections therebetween when stacked horizontally.

In particular, the first three-dimensional electrode module 602 can be electrically connected to the second three-dimensional electrode module 604 via the electrical connection between parts of the terminals of the first three-dimensional electrode module 602 facing away from planar portions of the first three-dimensional electrode module 602 and uncovered by insulation material and parts of the terminals of the second three-dimensional electrode module 604 facing away from planar portions of the second three-dimensional electrode module 604 and uncovered by insulation material. That is, those terminals forming the electrical connection between the first three-dimensional electrode module 602 and the second three-dimensional electrode module 604 can be uncovered by insulation materials.

When stacked horizontally as in FIG. 6A and FIG. 6B, the planar portions and PT C material of the first three-dimensional electrode module 602 can be offset 180° from the planar portions and PTC material of the second three-dimensional electrode module 604.

Although not specifically illustrated in FIG. 6A and FIG. 6B, it is to be understood that a third three-dimensional electrode module can also be stacked vertically on top of or below the first three-dimensional electrode module 602 and/or the second three-dimensional electrode module 604. and electrically connected in parallel via an electrical connection between terminals on a bottom or a top of the third three-dimensional electrode module and terminals on a bottom or a top of the first three-dimensional electrode module 602 and/or the second three-dimensional electrode module 604. That is, the terminals of the first three-dimensional electrode module 602 and/or the terminals of the second three-dimensional electrode module 604 can be located on both sides and tops and/or bottoms thereof to facilitate electrical connections when stacked both vertically and horizontally.

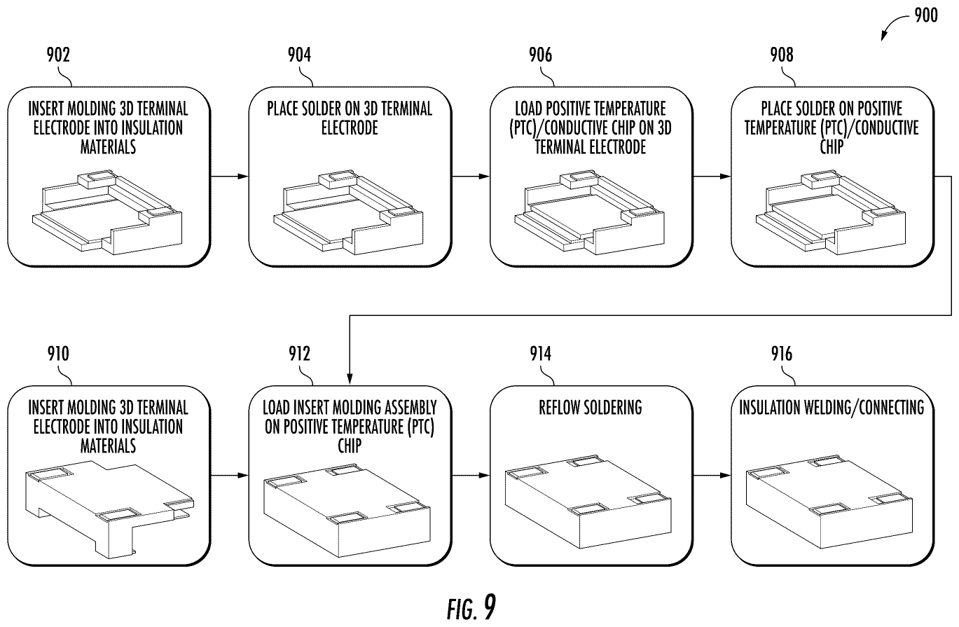

FIG. 7 illustrates a circuit 700 representative of a three-dimensional electrode system in accordance with disclosed embodiments. For example, the circuit 700 can represent the three-dimensional electrode system 500 or the three-dimensional electrode system 600. Each resistor R1, R2, R3, Rn in the circuit 700 is connected in parallel and can represent a resistance of PTC material in a three-dimensional electrode module in the three-dimensional electrode system. For example, if the three-dimensional electrode system includes X number of three-dimensional electrode modules, and each of those three-dimensional electrode modules includes one layer of PTC material, then the circuit 700 can include X number of resistors. However, if the three-dimensional electrode system includes X number of three-dimensional electrode modules, and each of those three-dimensional electrode modules includes Y layers of PTC material, then the circuit 700 can include X x Y number of resistors.

In any embodiment, a resistance of the three-dimensional electrode system can be calculated as follows:

$$R = \frac{1}{\frac{1}{R 1} + \frac{1}{R 2} + \frac{1}{R 3} + ⋯ + \frac{1}{Rn}}$$

FIG. 8 illustrates one embodiment of a method 800 of manufacturing a three-dimensional electrode module in accordance with disclosed embodiments. For example, the three-dimensional electrode module manufactured in accordance with the method 800 can include the three-dimensional electrode module 200, the three-dimensional electrode module 300, the three-dimensional electrode module 400, the three-dimensional electrode module 502, the three-dimensional electrode module 504, the three-dimensional electrode module 602, the three-dimensional electrode module 602, and/or the three-dimensional electrode module 604.

As seen in FIG. 8, the method 800 can include placing solder on a first three-dimensional electrode as in 802. For example, the first three-dimensional electrode can include the three-dimensional electrode 102, the three-dimensional electrode 112, the three-dimensional electrode 202, the three-dimensional electrode 204, the three-dimensional electrode 302, the three-dimensional electrode 304, the three-dimensional electrode 306, the three-dimensional electrode 308, the three-dimensional electrode 402, and/or the three-dimensional electrode 404, and the solder can be placed on a planar portion thereof.

Next, the method 800 can include loading PTC material on the first three-dimensional electrode as in 804. For example, the PTC material can be made of or from a solid sheet of the PTC material, a liquid version of the PTC material, and/or a conductive chip with the PTC material, and the PTC material can be loaded onto the first three-dimensional electrode by inserting the PTC material into or onto the solder on the first three-dimensional electrode.

Then, the method 800 can include placing solder on the PTC material as in 806 and loading a second three-dimensional electrode on the solder as in 808. For example, the second three-dimensional electrode can include the three-dimensional electrode 102, the three-dimensional electrode 112, the three-dimensional electrode 202, the three-dimensional electrode 204, the three-dimensional electrode 302, the three-dimensional electrode 304, the three-dimensional electrode 306, the three-dimensional electrode 308, the three-dimensional electrode 402, and/or the three-dimensional electrode 404, and the a planar portion thereof can be placed on the solder.

When a lower surface of the PTC material is placed on the solder on the first three-dimensional electrode as in 804, the solder can be placed on an upper surface of the PTC material as in 806. However, when the upper surface of the PTC material is placed on the solder on the first three-dimensional electrode as in 804, the solder can be placed on the lower surface of the PTC material as in 806. Similarly, when the solder and the PTC material are placed on a top surface of the planar portion of the first three-dimensional electrode as in 802 and 804, a bottom surface of the planar portion of the second three-dimensional electrode can be placed on the solder as in 808. However, when the solder and the PTC material are placed on the bottom surface of the planar portion of the first three-dimensional electrode as in 802 and 804, the top surface of the planar portion of the second three-dimensional electrode can be placed on the solder as in 808.

Finally, the method can include performing reflow soldering as in 810 and covering at least part of the first three-dimensional electrode and at least part of the second three-dimensional electrode with an insulation material as in 812. For example, the solder placed as in 802 and 806 can undergo reflow soldering as in 810. Further, the insulation material used to cover at least part of the first three-dimensional electrode and at least part of the second three-dimensional electrode can be any type of molding material or cap assembly as would be understood by one of ordinary skill in the art and applied as known by one of ordinary skill in the art.

FIG. 9 illustrates another embodiment of a method 900 of manufacturing a three-dimensional electrode module in accordance with disclosed embodiments. For example, the three-dimensional electrode module manufactured in accordance with the method 900 can include the three-dimensional electrode module 200, the three-dimensional electrode module 300, the three-dimensional electrode module 400, the three-dimensional electrode module 502, the three-dimensional electrode module 504, the three-dimensional electrode module 602, the three-dimensional electrode module 602, and/or the three-dimensional electrode module 604.

As seen in FIG. 9, the method 900 can include insert molding a first three-dimensional electrode into first insulation material as in 902 and insert molding a second three-dimensional electrode into second insulation material as in 910. For example, one or both of the first three-dimensional electrode and the second three-dimensional electrode can include the three-dimensional electrode 102, the three-dimensional electrode 112, the three-dimensional electrode 202, the three-dimensional electrode 204, the three-dimensional electrode 302, the three-dimensional electrode 304, the three-dimensional electrode 306, the three-dimensional electrode 308, the three-dimensional electrode 402, and/or the three-dimensional electrode 404, and one or both of the first insulation material and the second insulation material can be any type of molding material or cap assembly as would be understood by one of ordinary skill in the art. In some embodiments, at least part of the first three-dimensional electrode, such as parts of the terminals, can remain uncovered by the first insulation material after insert molding as in 902. Similarly, in some embodiments, at least part of the second three-dimensional electrode, such as parts of the terminals, can remain uncovered by the second insulation material after insert molding as in 910.

Next, the method 900 can include placing solder on the first three-dimensional electrode as in 904, loading PTC material on the first three-dimensional electrode as in 906, and placing solder on the PTC material as in 908. For example, the solder can be placed on a planar portion of the first three-dimensional electrode as in 904. The PTC material can be made of or from a solid sheet of the PTC material, a liquid version of the PTC material, and/or a conductive chip with the PTC material, and the PTC material can be loaded onto the first three-dimensional electrode by inserting the PTC material into or onto the solder on the first three-dimensional electrode. When a lower surface of the PTC material is placed on the solder on the first three-dimensional electrode as in 906, the solder can be placed on an upper surface of the PTC material as in 908. However, when the upper surface of the PTC material is placed on the solder on the first three-dimensional electrode as in 906, the solder can be placed on the lower surface of the PTC material as in 908.

Finally, the method 900 can include loading the assembly insert molded as in 910 on the solder as in 912, performing reflow soldering as in 914, for example, on the solder placed as in 904 and 908, and connecting the first insulation material with the second insulation material as in 916, for example, by welding or another connection method as would be known by one of ordinary skill in the art. When the solder and the PTC material are placed on a top surface of the planar portion of the first three-dimensional electrode as in 904 and 906, a bottom surface of the planar portion of the second three-dimensional electrode can be placed on the solder as in 910. However, when the solder and the PTC material are placed on the bottom surface of the planar portion of the first three-dimensional electrode as in 904 and 906, the top surface of the planar portion of the second three-dimensional electrode can be placed on the solder as in 910.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. A three-dimensional electrode comprising:
a planar portion for connecting with a positive temperature coefficient (PTC) material on a top surface thereof or a bottom surface thereof;
at least one expander portion electrically and physically connected with and perpendicular with the planar portion; and
one or more terminals electrically and physically connected with the at least one expander portion, the at least one expander portion vertically or horizontally offsetting the one or more terminals from the planar portion.

2. The three-dimensional electrode of claim 1 wherein the one or more terminals are parallel with the planar portion.

3. The three-dimensional electrode of claim 1 wherein the one or more terminals are perpendicular with the planar portion.

4. The three-dimensional electrode of claim 1 further comprising:
an insulation material covering at least part of the planar portion, the at least one expander portion, and the one or more terminals.

5. The three-dimensional electrode of claim 4 wherein at least part of the one or more terminals are uncovered by the insulation material.

6. The three-dimensional electrode of claim 5 wherein parts of the one or more terminals facing away from the planar portion are uncovered by the insulation material.

7. A module comprising:
a first three-dimensional electrode, the first three-dimensional electrode comprising:
a first planar portion connected with a positive temperature coefficient (PTC) material on a top surface thereof;
at least one first expander portion electrically and physically connected with and perpendicular with the first planar portion; and
one or more first terminals electrically and physically connected with the at least one first expander portion, the at least one first expander portion vertically or horizontally offsetting the one or more first terminals from the first planar portion;
a second three-dimensional electrode, the second three-dimensional electrode comprising:
a second planar portion connected with the PTC material on a bottom surface thereof;
at least one second expander portion electrically and physically connected with and perpendicular with the second planar portion; and
one or more second terminals electrically and physically connected with the at least one second expander portion, the at least one second expander portion vertically or horizontally offsetting the one or more second terminals from the second planar portion; and
an insulation material covering at least part of the first three-dimensional electrode and the second three-dimensional electrode.

8. The module of claim 7 wherein the one or more first terminals of the first three-dimensional electrode are parallel with the first planar portion of the first three-dimensional electrode, and wherein the one or more second terminals of the second three-dimensional electrode are parallel with the second planar portion of the second three-dimensional electrode.

9. The module of claim 7 wherein the one or more first terminals of the first three-dimensional electrode are perpendicular with the first planar portion of the first three-dimensional electrode, and wherein the one or more second terminals of the second three-dimensional electrode are perpendicular with the second planar portion of the second three-dimensional electrode.

10. The module of claim 7 wherein at least part of the one or more first terminals of the first three-dimensional electrode are uncovered by the insulation material, and wherein at least part of the one or more second terminals of the second three-dimensional electrode are uncovered by the insulation material.

11. The module of claim 10 wherein parts of the one or more first terminals of the first three-dimensional electrode facing away from the first planar portion of the first three-dimensional electrode are uncovered by the insulation material, and wherein parts of the one or more second terminals of the second three-dimensional electrode facing away from the second planar portion of the second three-dimensional electrode are uncovered by the insulation material.

12. The module of claim 7 wherein a lower surface of the PTC material is electrically connected to the top surface of the of the first planar portion of the first three-dimensional electrode, and wherein an upper surface of the PTC material is electrically connected to the bottom surface of the second planar portion of the second three-dimensional electrode.

13. A system comprising:
a first three-dimensional electrode module; and
a second three-dimensional electrode module electrically connected to the first three-dimensional electrode module,
wherein each of the first three-dimensional electrode module and the second three-dimensional electrode module comprises:
a first three-dimensional electrode, the first three-dimensional electrode comprising:
a first planar portion connected with a positive temperature coefficient (PTC) material on a top surface thereof;
at least one first expander portion electrically and physically connected with and perpendicular with the first planar portion; and
one or more first terminals electrically and physically connected with the at least one first expander portion, the at least one first expander portion
vertically or horizontally offsetting the one or more first terminals from the first planar portion;
a second three-dimensional electrode, the second three-dimensional electrode comprising:
a second planar portion connected with the PTC material on a bottom surface thereof;
at least one second expander portion electrically and physically connected with and perpendicular with the second planar portion; and
one or more second terminals electrically and physically connected with the at least one second expander portion, the at least one second expander portion vertically or horizontally offsetting the one or more second terminals from the second planar portion; and
an insulation material covering at least part of the first three-dimensional electrode and the second three-dimensional electrode.

14. The system of claim 13 wherein the one or more first terminals of the first three-dimensional electrode are parallel with the first planar portion of the first three-dimensional electrode, and wherein the one or more second terminals of the second three-dimensional electrode are parallel with the second planar portion of the second three-dimensional electrode.

15. The system of claim 13 wherein the one or more first terminals of the first three-dimensional electrode are perpendicular with the first planar portion of the first three-dimensional electrode, and wherein the one or more second terminals of the second three-dimensional electrode are perpendicular with the second planar portion of the second three-dimensional electrode.

16. The system of claim 13 wherein at least part of the one or more first terminals of the first three-dimensional electrode are uncovered by the insulation material, and wherein at least part of the one or more second terminals of the second three-dimensional electrode are uncovered by the insulation material.

17. The system of claim 16 wherein parts of the one or more first terminals of the first three-dimensional electrode facing away from the first planar portion of the first three-dimensional electrode are uncovered by the insulation material, and wherein parts of the one or more second terminals of the second three-dimensional electrode facing away from the second planar portion of the second three-dimensional electrode are uncovered by the insulation material.

18. The system of claim 17 wherein the first-three dimensional electrode module is vertically stacked on top of the second three-dimensional electrode module or horizontally stacked next to the second three-dimensional electrode module, and wherein the first three-dimensional electrode module is electrically connected to the second three-dimensional electrode module in parallel via an electrical connection between the parts of the one or more first terminals of the first three-dimensional electrode module facing away from the first planar portion of the first three-dimensional electrode module and uncovered by the insulation material and the parts of the one or more second terminals of the second three-dimensional electrode module facing away from the second planar portion of the second three-dimensional electrode module and uncovered by the insulation material.

19. The system of claim 13 wherein the first-three dimensional electrode module is vertically stacked on top of the second three-dimensional electrode module so that the first planar portion, the second planar portion, and the PTC material of the first three-dimensional electrode module are parallel with the first planar portion, the second planar portion, and the PTC material of the second three-dimensional electrode module, and wherein the first three-dimensional electrode module is electrically connected to the second three-dimensional electrode module in parallel.

20. The system of claim 13 wherein the first-three dimensional electrode module is horizontally stacked next to the second three-dimensional electrode module so that the first planar portion, the second planar portion, and the PTC material of the first three-dimensional electrode module are offset 180° from the first planar portion, the second planar portion, and the PTC material of the second three-dimensional electrode module, and wherein the first three-dimensional electrode module is electrically connected to the second three-dimensional electrode module in parallel.
